(19) United States
(12) Patent Application Publication
(10) Pub. No.: US 2014/0201644 A1
(43) Pub. Date: Jul. 17, 2014

(54) Method and Apparatus for Producing Digitally Edited Images

(71) Applicant: Campaigntrack pty Itd, Brookvale (AU)

(72) Inventor: Dirk Stefan Williams, Brookvale (AU)

(73) Assignee: Campaigntrack pty Itd, Brookvale (AU)

(21) Appl. No.: 13/950,199

(22) Filed: Jul. 24, 2013

(30) Foreign Application Priority Data
Jan. 17, 2013 (AU) 2013900150

(51) Int. Cl. G06F 3/0484

(52) U.S. Cl. CPC G06F 3/04845
USPC 715/738

(57) ABSTRACT

A method and apparatus for producing a result digital image from a selection of a plurality of original digital images. The apparatus comprising: a remote computing device having an image management module, the remote computing device being coupleable to a data network, the image management module accesses a plurality of original digital images and generates a respective plurality of preview digital images, each preview digital images having a smaller data size than the respective original digital image; a remote database server for storing the respective preview digital image, each of the plurality of preview digital images being associated with a job record; a remote user interface server for presenting a user interface indicative of the job record and enabling viewing of the plurality of preview digital images; wherein the user interface enables selection of one or more preview digital images, and causes the respective one or more original digital images to be transferred from the remote computing device for production of the result digital image.

### FIELD OF THE INVENTION

The present invention relates to digital image production and in particular to producing a digital image from a selection of a plurality of digital images.

The invention has been developed primarily for use as a method and apparatus for producing a result digital image from a selection of a plurality of digital images captured remotely, and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

### OBJECT OF THE INVENTION

It is an object of the present invention to overcome or ameliorate at least one of the disadvantages of the prior art, or to provide a useful alternative.

It is an object of the invention in its preferred form to provide an apparatus for producing a result digital image from a selection of a plurality of digital images.

### SUMMARY OF THE INVENTION

According to an aspect of the invention there is provided an apparatus for producing a result digital image from a selection of a plurality of original digital images, wherein preferably only the respectively selected one or more original digital images are automatically transferred from the remote computing device to by a remote image-edit studio device.

According to a further aspect of the invention there is provided an apparatus for producing a result digital image from a selection of a plurality of original digital images, the apparatus comprising:
a remote computing device having an image management module, the remote computing device being coupleable to a data network, the image management module accesses a plurality of original digital images and generates a respective plurality of preview digital images, each preview digital images having a smaller data size than the respective original digital image;
a remote database server for storing the respective preview digital image, each of the plurality of preview digital images being associated with a job record;
a remote user interface server for presenting a user interface indicative of the job record and enabling viewing of the plurality of preview digital images;
wherein the user interface enables selection of one or more preview digital images, and causes the respective one or more original digital images to be transferred from the remote computing device for production of the result digital image.

Preferably, only the respectively selected one or more original digital images are automatically transferred from the remote computing device.

Preferably, the respectively selected one or more original digital images are transferred across the data network to a remote photo editing studio device that produces the result digital image. More preferably, each of the plurality of original digital images are raw digital images generated by a digital camera.

Preferably, the respectively selected one or more original digital images are directly copied from the remote computing device to the remote photo editing studio device. More preferably, only the respectively selected one or more original digital images are automatically transferred from the remote computing device.

Preferably, the respectively selected one or more original digital images are first copied to the remote database server and then directly copied to the studio local store.

According to a further aspect of the invention there is provided a method implemented on a computing apparatus for producing a result digital image from a selection of a plurality of original digital images, the method including the steps of:
obtaining and storing the plurality of original digital images on a remote computing device;
associating the original digital images with a job record;
generating a preview digital image for each original digital image; each preview digital images having a smaller data size than the respective original digital image;
storing each preview digital image;

associating each preview digital image with the job record;
receiving a selection of one or more preview digital images for the purpose of requesting respectively selected one or more original digital images; and
providing each respectively selected one or more original digital images for storage on a data store accessible by a remote image-edit studio device.

According to a further aspect of the invention there is provided a user access interface for a processor device, the processor device being coupleable to database having a job record associated with a plurality of preview digital images, the preview digital images being associated with a respective original digital image stored on a remote computing device, the processor device being adapted to present the plurality of preview digital images, the interface comprising:
a control program adapted to enable selection of one or more preview digital images for enabling receipt of respectively selected one or more original digital images; and storing each of the respectively selected one or more original digital images on a data store accessible by an image-edit studio.

According to a further aspect of the invention there is provided an apparatus for producing a result digital image from a selection of a plurality of digital images, the apparatus comprising:
a remote computing device having an image management module; the remote computing device being coupleable to a data network; wherein the image management module accesses a plurality of original (or raw) digital images and generates a respective plurality of preview digital images;
a remote database server for storing the respective preview digital image; the plurality of preview digital images being associated with a job record;
a remote user interface server for presenting a user interface indicative of a job record and enabling viewing of the plurality of preview digital images;
wherein the user interface enables selection of one or more preview digital images, which causes only the respective one or more original (or raw) digital images to be transferred from the remote computing device for access by a photo editing studio.

Preferably, the one or more original (or raw) digital images are high resolution digital images.

Preferably, the remote computing device is wirelessly coupled to the data network.

Preferably, a remote server device has the remote database server and the remote user interface server. Alternatively, the remote computing device has the remote database server and the remote user interface server.

Preferably, the respectively selected one or more original (or raw) digital images are directly copied to a studio local store. Alternatively, the respectively selected one or more original (or raw) digital images are first copied to the remote database server and then directly copied to the studio local store.

According to a further aspect of the invention there is provided a method of producing a result digital image from a selection of a plurality of digital images, the method including the steps of:
obtaining and storing a plurality of original (or raw) digital images onto a remote computing device;
associating the original or raw images with a job entity or record;
generating a preview digital image for each original (or raw) digital image;
storing each preview digital image on a remote database server associated with a job entity or record;
selecting one or more preview digital images for the purpose of requesting respectively selected one or more original (or raw) digital images; and
storing each respectively selected one or more original (or raw) digital images on a data store accessible by an image-edit studio.

Preferably, the one or more original (or raw) digital images are high resolution digital images.

According to a further aspect of the invention there is provided a user access interface for a processor device, the processor device being coupleable to database having a job record associated with a plurality of preview digital images; the processor device being adapted present the plurality of preview digital images; the interface comprising:
a control program adapted to enable selection of one or more preview digital images for requesting respectively selected one or more original (or raw) digital images; and
storing each of the respectively selected one or more original (or raw) digital images on a data store accessible by an image-edit studio.

According to a further aspect of the invention there is provided a computer program product stored on a computer usable medium, the computer program product adapted to provide a method as herein described.

### BRIEF DESCRIPTION OF THE DRAWINGS

A preferred embodiment of the invention will now be described, by way of example only, with reference to the accompanying drawings in which:

FIG. 1 shows a schematic view of an embodiment apparatus for producing a result digital image from a selection of a plurality of digital images;

FIG. 2 shows a schematic view of an embodiment apparatus for producing a result digital image from a selection of a plurality of digital images; and

FIG. 3 shows a flowchart for an embodiment method of producing a result digital image from a selection of a plurality of digital images.

### PREFERRED EMBODIMENT OF THE INVENTION

Producing a composite image (including computer facilitated hand retouching) from image data from a plurality of original image raw files.

A further example of preparing a digital image from a image from a selection of a plurality of raw or original digital images includes digital image collages, multiple exposure compositing and digital image panorama. The preparation of these images typically require image editing including, by way of example only, contrast adjustment, brightness adjustment, colour balance adjustment, selection cutting and pasting, layering and masking of multiple images of the same scene with different exposure and flash characteristics, cropping and scaling. It will be appreciated that image editing can include selectively blending a portion of each of a plurality of original or raw digital images to prepare a result image.

A further example of preparing a digital image from an image from a selection of a plurality of raw digital images includes high dynamic range imaging (HDRI or HDR) is a set of methods used in imaging and photography, to allow a greater dynamic range between the lightest and darkest areas of an image than current standard digital imaging methods or photographic methods. HDR images can represent more accurately the range of intensity levels found in real scenes, from direct sunlight to faint starlight, and is often captured by way of a plurality of differently exposed pictures of the same subject matter. High-dynamic-range photographs are generally achieved by capturing multiple standard photographs, often using exposure bracketing, and masking to exclude unwanted portions of any component image and then merging them into an HDR image. Digital photographs are often encoded in a camera's raw image format, because JPEG encoding may not offer sufficient values to allow fine transitions (and introduces undesirable effects due to the lossy compression).

The apparatus and method is used in digital image production that requires image editing/retouching after a plurality of original (or raw) images are captured. In particular, the method and apparatus can be used for producing a result digital image from a selection of a plurality of digital images captured remotely. By way of example, professional real estate photography requires remote capture of a large number of images that must be promptly processed to produce a resultant image for advertising purposes.

It will be appreciated that this apparatus and method can provide advantages, by way of example, including: reducing data transmission for remotely captured images such that only required original images are transferred; and time effectiveness by allowing initial evaluation to be taken prior to availability of original images captured.

It will be appreciated that a professional real estate photography typically captures a large number of images that must be promptly processed to produce a resultant image for advertising purposes. Processing of a result image, requires the photographers to capture multiple images using different settings (typically aperture, exposure and flash settings) of each scene or view frame, such that a photo editing process can composite and blend the best selected portions of the plurality of original or raw digital images into a result digital image.

A professional photographer typically captures each original images in a format called RAW, which is a large lossless digital image file. Each RAW digital image file can be in the order of tens of megabytes. By way of example only, a substantial number of RAW digital images (such as 20 RAW digital images) can be captured for the purpose of producing a single result digital image. Although a substantial number of RAW digital images are captured for the purpose of producing a single result digital image—only a selection of these RAW digital images are typically used or edited in producing a blended result digital image.

As a result digital image may only be composed of a selection of RAW digital images, initially captured for the purpose of producing the result digital image, only a select portion of the significant amount of image data captured is actually required for image editing. As image capture can occur remotely, pre-selection of raw images required for editing can reduce the amount of data transferred to a photo editing studio. The method and apparatus can substantially reduce the amount of data that is transmitted to a photo editing studio.

By way of example only, many professional photographers work in the field, being remote from an image editing studio. In such situations a photographer can typically only access wireless data communication networks (based on Wi-Fi services or mobile telephony services) which provide limited bandwidth. For example, in the case of mobile telephone communications, transmitting large volumes of data can be costly. A significant reduction in required data transmission to an image editing studio can enable effective mobile (in-field) data transfer.

By way of example only, professional photographers can return to a convenient fixed location, such as their own residence, with photographs taken and load such photographs onto a PC running software designed to facilitate the remote aspect of the disclosed embodiments.

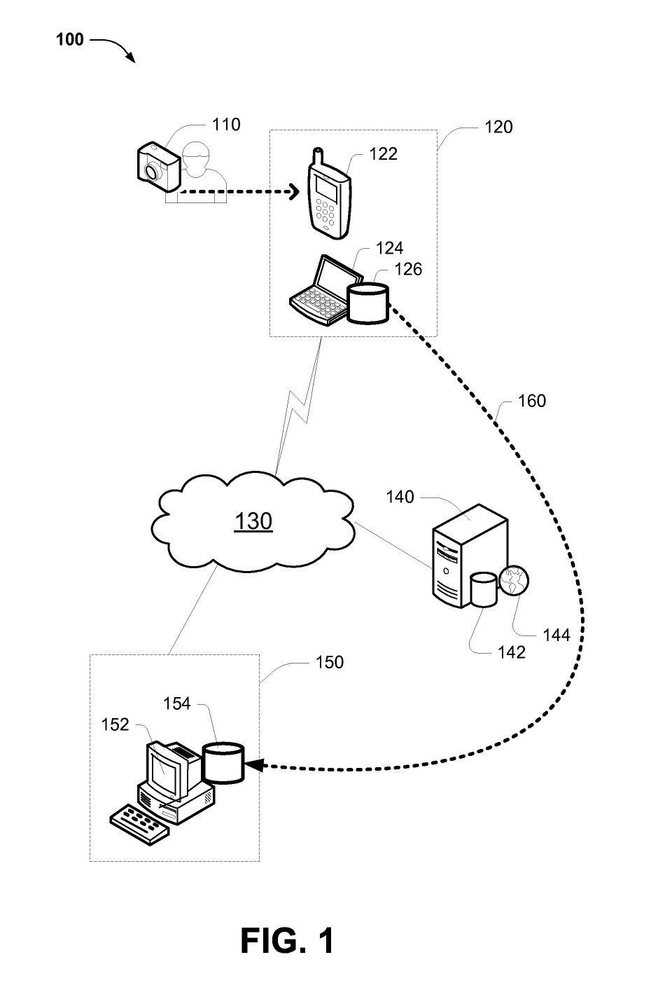

FIG. 1 shows a schematic diagram of an apparatus 100 for producing a result digital image from a selection of a plurality of digital images.

In this embodiment apparatus 100, a photographer captures original or raw digital images using a digital camera 110. The original or raw digital images are communicated to a remote computing device 120. The remote computing device can include, by way of example, a mobile phone, tablet, computer or laptop (122, 124). The remote computing device 120 being wired or wirelessly in communication with a data network 130. The original or raw digital images can be communicated to the remote computing device by directly connecting the camera (using wired or wireless communication) or media (media card), and stored in a database storage 126.

An image management module on the remote computing device can enable the creation or selection of a relevant job entity (or record) for association with each original or raw digital image captured and/or stored. The job entity may further include details relevant to the photographic assignment including the type and number of results and images required. Accordingly, a photographer may access the job entity to confirm the scope of work required.

The image management module can enable selective association of original or raw digital images with the job entity. Having associated one or more original or raw digital images with a job entity, the image management module can generate a lower resolution preview version of each associated original or raw digital image. The respective preview digital image having a substantially lower file size while retaining sufficient resolution and quality for viewing and image selection. The image management software may also save the original or raw digital images to local storage 126 on the remote computing device such that the camera or media may be removed or disconnected.

The remote computing device, via the image management module, communicates or transmits each respective preview image to a remote server or remote server device 140.

The image management module can further update a respective job entry on the remote server. The remote server stores the preview images and job entity data in a database (or database server) 142. The image management module may further provide relevant detail about each preview digital image, including a reference (for example, a name) of each respective original or raw digital image and the remote computing device that stores the original or raw digital image and optionally other information about the digital image. Alternatively, the remote server may periodically contact (or poll) the remote computing device and image management module to request if any updates for a job entity (or relevant preview files) have been made available which would then be transmitted by (or pulled from) the remote computing device. This makes available a respective preview digital image for each available original or raw digital image captured for a particular job entity.

The remote server provides an interface server 144 (for example, providing a web based interface or a proprietary software based interface) for presenting to a studio 150 a studio interface 152 for enabling access to the status of a job entity that the studio is to provide (or has provided) imagine editing. The studio interface can present available or additional information in relation to a job entity, including indication if a respective low resolution preview digital images for that job have been made available, or if a requested original or raw digital image has been delivered.

A studio image editor can view the interface to determine if new preview digital images have been made available, and access available preview images. The interface can provide a means of viewing all available preview images in order to allow the editor to determine which original images will be suitable for inclusion in the edited result image. The interface enables selection of one or more preview digital images for which the original or raw digital images are required. This may further optionally enable selection of whether the studio requires the original or raw digital images to be provided as a RAW image file or a high resolution JPG image file—in the event that both RAW and JPG images have been provided by the photographer or are created. Having selected one or more preview digital images (and respective original or raw digital images) the interface communicates the studio's requirements to the remote server which in-turn communicates its requirements to the remote computing device. Alternatively, the studio interface may directly communicate with the remote computing device to request the selected original or raw digital images. The selectively requested original or raw digital image files are transferred or copied 160 from the remote computing device data store 126 the studio local data store 154. Alternatively the requested original or RAW digital image files may be transferred to the remote server for access by the Image Editing Studio.

The interface can then indicate when the selected original or raw digital images have been transferred such that they are available to the studio. Upon availability of the selected original or raw digital images, the selected images can then be used to create one or more result images associated with the job entity. As an option the creation of any result image can be notified to the interface, for transmission to, or collection by, the remote server.

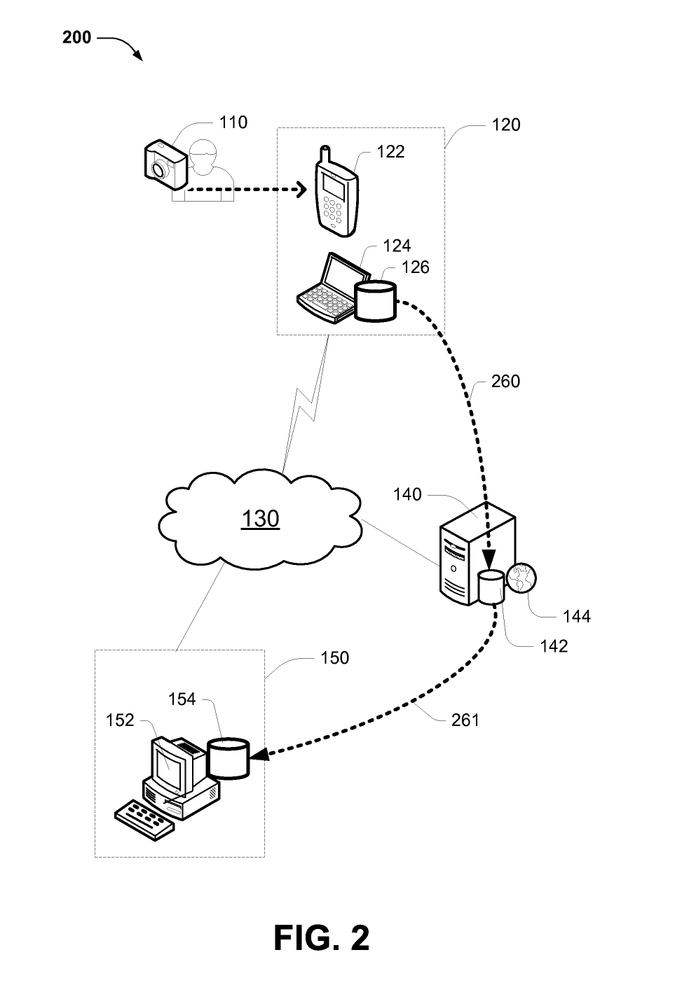

FIG. 2 shows a schematic diagram of an apparatus 200 for producing a result digital image from a selection of a plurality of digital images. In this embodiment apparatus, a studio interface enables selection of one or more preview digital images for which the original or raw digital images are required. This may further optionally enable selection of whether the studio requires the original or raw digital images to be provided as a RAW image file or a JPG image file—in the event that both RAW and JPG images have been provided or are created. Having selected one or more preview digital images (and respective original or raw digital images) the interface transmits the studio's requirements to the remote server. Alternatively, the studio interface may directly communicate with the remote computing device to request the selected original or raw digital images. In this embodiment, the requested original or raw digital image files are further transferred or copied 260 from the remote computing device data store 126 to the remote server database 142 and then automatically transferred or copied 261 from the remote server database 142 to the studio local data store 154.

It will be appreciated that, in an example embodiment, the remote computing device can also be the remote server.

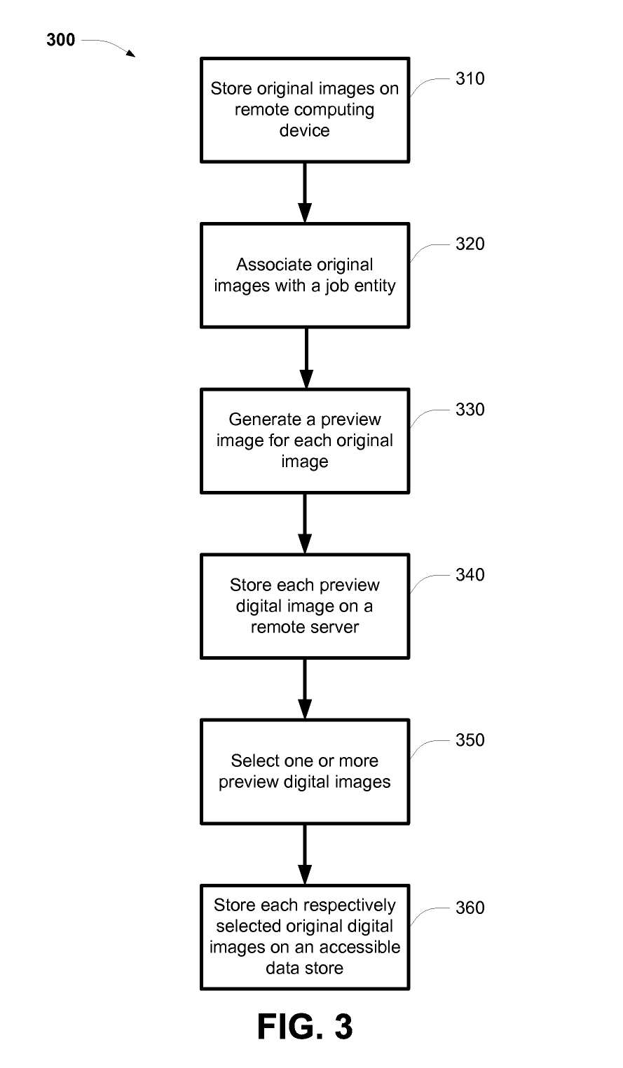

FIG. 3 shows a flowchart for an embodiment method 300 of producing a result digital image from a selection of a plurality of digital images. The method 300 comprises the steps of:
STEP 310: obtaining a plurality of original (or raw) digital images on a remote computing device;
STEP 320: associating the original or raw images with a job entity or record;
STEP 330: generating a preview digital image for each original (or raw) digital image;
STEP 340: storing each preview digital image on a remote server;
STEP 350: selecting one or more preview digital images for requesting respectively selected one or more original (or raw) digital images; and
STEP 360: storing each respectively selected one or more original (or raw) digital images on a data store accessible by an image-edit studio.

Further embodiment methods and apparatus of producing a result digital image from a selection of a plurality of digital images will be taught by way of example only.

In an embodiment, a photographer captures a plurality of original or raw digital images for a given photo-shoot job entity. The camera or media (SD card, etc) on which the original or raw digital images are stored is connected to a mobile remote computing device having an image management module (for example, a customised application). For example, the image management module may be controlled via a standalone application interface or a browser based interface. A relevant job entity can be selected or created.

A relevant job entity can be selected from a list of pre-created job entities. This list may be retrieved from a list of all available job entities stored on the database server. A relevant job entity can be created as a new job entity, which can then be created and stored in the database server. It will be appreciated that the job entity acts as a ‘container’ for all digital images associated with the job. The job entity may also include details of the job including type and number of photographs required, which may be presented by the image management module. A photographer may use the image management module to review job requirements prior to taking photographs.

Upon selection or creation of a relevant job entity, the image management module enables selection of one or more (or all) digital image stored on the camera or storage media as relating to the respective job. The application may copy the original or raw image files for each selected digital image including any RAW format files, to the remote computing device. Alternatively, the image management module can enable one or more (or all) digital images stored on the camera or storage media to be first copied to the remote computing device and subsequently selected and associated with a relevant job entity. Having associated one or more original or raw digital images with a job entity, the image management module can generate a lower resolution preview digital image (having a significantly lesser file size) of each of the selected original or raw digital image. The preview digital image being suitable for viewing on a computer screen at a size appropriate for selection by an Image Editor at the Image Editing Studio.

The image management module may identify if a lower resolution jpg companion digital image file does not exist for each original or raw image file, such that a lower resolution preview digital image is created and available for each original or raw image file. If companion jpg files exist, they may be copied and suitably resized for viewing and selection.

The image management module may copy the original or raw digital image (including RAW format files), along with any created preview digital images, to a local storage medium coupled to the remote computing device, such that the camera or media may be removed. It will be appreciated that local storage of the image files can occur at any time the camera or media are coupled to the remote computing device.

The image management module can upload, or otherwise deliver or provide, a copy of each preview digital image to a remote centralised server. In addition, image management module can notify or record features of each preview image associated with a job record (or job element) maintained by the remote central database, including filenames and location of the preview and/or original image files, the identification of the remote computing device that stores the original or raw image files. Other relevant information can also be stored about each digital image or job element. Alternatively, the remote central server can poll the remote computing device (or image management module) and request any new job elements (or updated details of a job element) and relevant preview digital image files associated with those job elements be transmitted to the remote central server database—either pushed by the remote computing device or pulled down by the remote central server.

The remote central server includes a web server and web interface that enables publishing each preview digital image. For each preview digital image, the web server can also register the associated file name and location, respective remote computing device, and associated job record details.

At a photo-editing studio, a studio interface (for example a browser interface or a proprietary application interface) can present each job record that the respective studio is to provide image editing. The studio interface may present a task queue. The studio interface may present additional information on each job record. For example, the studio interface can indicate if preview digital images are available for viewing, or if subsequently requested high resolution original files have been delivered. Using the interface, the studio can access a job record and view the associated preview images. The interface can allow the studio to select the preview images for which they would like the high resolution original files. The interface may further allow the studio to select whether high resolution digital images are required in a RAW file format or a JPG file format—in the event that the original or raw images were provided by the photographer in both a RAW and JPG file format on the remote device. Having selected one or more images, the studio uses the interface to notify the central database server of their requirements for which high resolution original or raw digital images are required, which can then be communicated to the remote computing device. Alternatively, studio interface may directly request the high resolution digital image files from the remote computing device directly. The remote computing device can transmit (or push) the requested original or raw digital image files to a studio database storage. Alternatively, the studio interface may directly access the remote computing device and directly download the files required. Alternatively, the studio interface may communicate its request for high resolution original files to the central database server which in turn either directly retrieves the high resolution original files from the remote device or requests the remote device to transmit the requested original files.

A preferred workflow would involves a studio request for selected original or raw image files being made through the studio interface to the central database server. The central database server would then communicate the requirement to the remote computing device or image management module, which would then transfer the requested image files to a studio database store. Transfer can typically be achieved electronically using a file transfer protocol (FTP), Virtual Private Network facilitated file copy or the like. Requested files can be automatically placed into folders that are named and/or organized according to job element, and process status (original images or result images).

Upon selected high resolution original digital image files being made available to the studio, the studio can use the original files to create one or more final result digital image relating to the job record.

Upon generation or creation of each result digital image, the studio interface can be updated to managing the final edited images. Alternatively, predetermined folders may be monitored by the studio interface or the remote central database server. For example, by using a predetermined file folder for each job element, or a predetermined naming convention for the edited images (that includes the job number or identifier in the name) the studio can provide the edited images in a software monitored folder. The monitoring can include periodic polling/scanning of folder contents, or through a studio interface (or software interface) that enables identification of edited images being made available for a job entity. A studio database storage, or a central server database, can then upload or retrieve the finished edited images to the central server database. Typically, automated uploading of the edited images can trigger a status change on the job, resulting in the job entity or result image to have an associated status set to a quality control review, client proofing or editing complete status. Upon completion of a job entity, notification may be automatically forwarded to the photographer and/or the client of the photographer for review and approval. Notification may include transmitting of a low resolution preview image or a high resolution result image (which initially could be optionally watermarked).

The remote computing device (under control of the image management module or other software module) can enable delivery or retrieval of each high resolution original digital image file requested. The remote computing device can receive requests for high resolution original file delivery by various methods including polling and push notification. The remote computing device can typically deliver any requested files automatically. Files would typically be delivered using a file transfer protocol (FTP). However, it would be appreciated that other file transfer methods could be used, which by way of example can include: a direct virtual private network (VPN) could be established to enable a direct file copy; and a http file transfer. Upon delivery of any requested image file, the remote computing device may notify the central database server that the file has been delivered.

The remote computing device can also poll the web server or await a push notification for uploading or delivery of selected original or raw digital image files to a specified FTP studio location. Upon receiving such a request the remote computing device can FTP the specified original or raw digital image files to a remote database store location (as specified in the FTP request). At the completion of an FTP transfer the remote computing device can notify the web server that the file has been transferred. Optionally the remote computing device can transfer the remoter database server or a remote studio database store. The selected original or raw digital image files are finally saved in a remote studio database store that is accessible by the image edit studio.

It will be appreciated that the illustrated embodiments disclose methods and apparatus for producing a result digital image from a selection of a plurality of digital images.

Interpretation

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. An apparatus for producing a result digital image from a selection of a plurality of original digital images, the apparatus comprising:
a remote computing device having an image management module, the remote computing device being coupleable to a data network, the image management module accesses a plurality of original digital images and generates a respective plurality of preview digital images, each preview digital images having a smaller data size than the respective original digital image;
a remote database server for storing the respective preview digital image, each of the plurality of preview digital images being associated with a job record;
a remote user interface server for presenting a user interface indicative of the job record and enabling viewing of the plurality of preview digital images;
wherein the user interface enables selection of one or more preview digital images, and causes the respective one or more original digital images to be transferred from the remote computing device for production of the result digital image.

2. The apparatus according to claim 1, wherein only the respectively selected one or more original digital images are automatically transferred from the remote computing device.

3. The apparatus according to claim 1, wherein the respectively selected one or more original digital images are transferred across the data network to a remote photo editing studio device that produces the result digital image.

4. The apparatus according to claim 3, wherein each of the plurality of original digital images are raw digital images generated by a digital camera.

5. The apparatus according to claim 3, wherein the respectively selected one or more original digital images are directly copied from the remote computing device to the remote photo editing studio device.

6. The apparatus according to claim 5, wherein only the respectively selected one or more original digital images are automatically transferred from the remote computing device.

7. The apparatus according to claim 2, wherein the respectively selected one or more original digital images are first copied to the remote database server and then directly copied to the studio local store.

8. The apparatus according to claim 1, wherein the one or more original digital images are high resolution digital images.

9. The apparatus according to claim 8, wherein each of the plurality of original digital images are raw digital images generated by a digital camera.

10. The apparatus according to claim 1, wherein the remote computing device is wirelessly coupled to the data network.

11. The apparatus according to claim 1, wherein a remote server device has the remote database server and the remote user interface server.

10. The apparatus according to claim 1, wherein the remote computing device has the remote database server and the remote user interface server.

12. The apparatus according to claim 1, wherein each of the plurality of original digital images are raw digital images generated by a digital camera.

13. A method implemented on a computing apparatus for producing a result digital image from a selection of a plurality of original digital images, the method including the steps of:
obtaining and storing the plurality of original digital images on a remote computing device;
associating the original digital images with a job record;
generating a preview digital image for each original digital image; each preview digital images having a smaller data size than the respective original digital image;
storing each preview digital image;
associating each preview digital image with the job record;
receiving a selection of one or more preview digital images for the purpose of requesting respectively selected one or more original digital images; and
providing each respectively selected one or more original digital images for storage on a data store accessible by a remote image-edit studio device.

14. The method according to claim 13, wherein the one or more original digital images are high resolution digital images.

15. The method according to claim 14, wherein each of the plurality of original digital images are raw digital images generated by a digital camera.

16. The method according to claim 15, wherein only the respectively selected one or more original digital images are automatically transferred from the remote computing device.

17. A user access interface for a processor device, the processor device being coupleable to database having a job record associated with a plurality of preview digital images, the preview digital images being associated with a respective original digital image stored on a remote computing device, the processor device being adapted to present the plurality of preview digital images, the interface comprising:
a control program adapted to enable selection of one or more preview digital images for enabling receipt of respectively selected one or more original digital images; and storing each of the respectively selected one or more original digital images on a data store accessible by an image-edit studio.

18. The interface according to claim 17, wherein the one or more original digital images are high resolution digital images.

19. The interface according to claim 18, wherein each of the plurality of original digital images are raw digital images generated by a digital camera.

20. The interface according to claim 19, wherein only the respectively selected one or more original digital images are automatically transferred from the remote computing device.
